(19) United States
(12) Patent Application Publication
(10) Pub. No.: US 2002/0141063 A1
(43) Pub. Date: Oct. 3, 2002

(54) Method for spectral filtering of optical radiation

(76) Inventors: Michael P. Petrov, St. Petersburg (RU); Alexander V. Shamrai, St. Petersburg (RU); Victor M. Petrov, St. Petersburg (RU); Alexander P. Paugurt, St. Petersburg (RU)

Correspondence Address: BROWN, RUDNICK, BERLACK & ISRAELS, LLP., BOX IP, 18TH FLOOR, ONE FINANCIAL CENTER, BOSTON, MA, 02111, US

(21) Appl. No.: 10/044,560

(22) Filed: Jan. 9, 2002

Related U.S. Application Data
(60) Provisional application No. 60/260,545, filed on Jan. 9, 2001.

(51) Int. Cl. G02B 5/18; G02B 27/42; G02B 27/44

(52) U.S. Cl. 359/566; 359/558

(57) ABSTRACT

The present invention provides a device and method of spectral filtration of optical radiation by forming a holographic diffraction grating in a photorefractive medium. The photorefractive medium can be a crystal, a polymer or any other material with suitable photorefractive properties. The wavelength of the filtered radiation can be selected depending on the electrooptical properties of the photorefractive material, by applying an electric field and, in addition, by sufficiently high transfer function parameters achieved due to a high diffraction efficiency of the grating can be obtained. According to the invention, the method for spectral filtering of optical radiation based on diffraction from a holographic diffraction grating comprises forming the grating in a photorefractive material by directing two coherent light beams onto a face of the photorefractive material at some angle, intersecting two coherent light beams inside the material and directing a radiation beam onto the photorefractive material preferably along the diffraction grating wave vector. The direction of the grating wave vector in the described system is not parallel to the directions of propagation of the two coherent light beams.

This application claims priority from an earlier filed U.S. Provisional patent application Serial No. 60/260,545, filed on Jan. 9, 2001, which application is incorporated by reference herein.

### FIELD OF THE INVENTION

The present invention relates to optics and particularly to the optical methods and devices for spectral filtration of optical radiation using photorefractive crystals. More particularly, the present invention relates to narrow-band filters with a broad wavelength tuning range.

### BACKGROUND OF THE INVENTION

Methods of spectral filtration of optical radiation based on diffraction of the radiation from a holographic grating pre-recorded and fixed in a photorefractive crystal are known in the art. Examples of these methods were given in the paper entitled “Volume holographic narrow-band optical filter”, Optics Letters, Vol.18, No.6, pp.459-461 (1993); in U.S. Pat. No. 5,684,611 “Photorefractive Systems and Methods”; and U.S. Pat. No. 5,796,096 “Fabrication and Applications of Long-Lifetime, Holographic Gratings in Photorefractive Materials”. The grating is recorded as follows: two recording coherent light beams form an interference pattern in a crystal. In accordance with the formed interference pattern, a redistribution of electric charges characterized by a local variation in the index of refraction occurs in the crystal. During the process of recording the holographic grating, the light beams forming the interference pattern can be directed onto a face of the crystal, as described in “Photorefractive Materials and their Applications II: Survey of Applications”, Edited by P. Gunter and J.-P. Huignard, Springer-Verlag Berlin Heidelberg (1989), or counterpropagating beams can be directed on opposite faces of the crystal. Since the diffraction grating recorded by the above-described method is not stable and decays on exposure to light, the grating is fixed by heating the crystal and keeping it at an elevated temperature for a specified period of time. Consequently, the mobility of mono-valent ions in the crystal increases, so they acquire the ability to move inside the crystal, compensating for the charge redistribution mentioned above. After temperature is lowered, an ionic lattice is formed and fixed in the crystal, retaining its properties for several years even under intense illumination.

Spectral filtering is performed by illuminating a crystal with a polychromatic light beam in the direction nearly parallel to the wave vector of the recorded and fixed grating. The wavelengths of a spectral component satisfying the Bragg condition are reflected from the grating, while the wavelengths in the remaining spectral range not satisfying the Bragg condition pass through the optically transparent crystal. In other words, the grating reflects the light in a particular narrow wavelength range, the central wavelength λᵣ of which satisfies the Bragg condition:

λᵣ=2nΛ, (1)

where n is an average index of refraction of the crystal, and Λ is the diffraction grating spacing.

Spectral selectivity of a filter depends on the length and amplitude of the grating. For a small grating amplitude the selectivity can be described by:

$$\frac{{δλ}_{r}}{{λ}_{r}} = \frac{Λ}{T} , \qquad ( 2 )$$

where δλᵣ is the spectral width of the reflected signal, and T is the length of the diffraction grating.

The magnitude of λᵣ can be selected by generating an electric field with a specific strength E in the crystal. Due to the linear electrooptical effect (the Pockels effect) in photorefractive materials, variation of an average index of refraction n for a defined polarization of the passing light depends on electric field strength E as:

$$Δ n = \frac{1}{2} {n}_{0}^{3} rE , \qquad ( 3 )$$

where Δn is a refractive index variation, n₀ is an average index of refraction for E=0, and r is an effective electrooptical coefficient that depends on the direction of electric field E relative to the principal crystallographic axes and on the direction of polarization of the incoming light beam.

By changing field strength E, the filter is tuned and a particular spectral component (filtered radiation) wavelength λᵣ is selected.

In order to fabricate a spectral optical filter with a wide range of turnable wavelengths λᵣ, a crystal with a high electrooptical coefficient is needed. Unfortunately, a widely used lithium niobate (LiNbO₃) has a relatively low electrooptical coefficient.

Crystals exhibiting a high electrooptical coefficient, such as barium titanate (BaTiO₃), potassium niobate (KaNbO₃), and barium-strontium niobate (SBN) have low diffraction efficiency of fixed gratings, and therefore their use in filters can be problematic.

Another method of spectral filtration is not to fix a grating in a crystal, but to form the grating in the crystal by intersecting coherent light beams inside the crystal.

In particular, the article “Narrow-band WDM spectrum analyzer without mechanical tuning”, Electronics Letters, Vol.32, No.9, pp.838-839 (1996), describes a spectral optical filter used in an analyzer. The filter is based on a photorefractive crystal and operates in the manner described above. A holographic diffraction grating is formed (recorded) in a crystal by two counterpropagating coherent recording light beams, one of which is generated by a tunable laser and the other one is provided by reflecting the first light beam from a mirror. Simultaneously, a polychromatic light beam is directed onto the crystal preferentially along the wave vector of the diffraction grating. The diffracted light beam reflected from the grating is detected by a photodetector. The reflected light beam has a narrow spectral band with the central wavelength λᵣ satisfying the Bragg condition (1). Operation of the analyzer in which the described optical filter is used based on varying in the spacing Λ of the recorded diffraction grating by tuning the wavelength of the laser. For different Λₛ different λ_{w} in the reflected beam will satisfy the Bragg condition. Thus, the filter can be tuned up to a particular λᵣ based on the wavelength λ_{w} of the optical radiation of the recording beams used to record the diffraction grating. Such a filter is called an optically tunable filter.

However, in the above-described method of the filter is not tuned, because electrooptical properties of the crystal cannot be utilized, as would be the case if the diffraction grating were fixed in the crystal. If an electric field of strength E affecting the average index of refraction no is applied to the crystal, the spacing of the grating recorded in counterpropagating beams will be:

$${Λ}_{E} = \frac{{λ}_{w}}{2 {n}_{E}} , \qquad ( 4 )$$

where n_{E} is the average index of refraction of the crystal in the electric field of strength E. The wavelength of the beam reflected from the grating in accordance with the Bragg diffraction will be:

λᵣ=2n_{E}Λ_{E}. (5)

It follows from Eqs. (4) and (5) that if the diffraction grating is recorded in counterpropagating beams and the radiation to be filtered is incident along the wave vector of the grating, then λᵣ=λ_{w} and λᵣ is independent of the refractive index of the crystal. Hence, it is impossible to use the electrooptical properties of the crystal to tune the filter.

Another method of spectral filtration of optical radiation is based on diffracting the light on a holographic grating which is not fixed in a photorefractive crystal, such as the method described in “Optically tunable optical filter”, Applied Optics, Vol.34, No.35, pp.8230-8235 (1995). The diffraction grating is formed (recorded) by two coherent light beams impinging onto the same face of the crystal and intersecting in the crystal. The incoming polychromatic radiation impinges on the same face of the crystal and forms an angle with the wave vector of the diffraction grating. Due to the Bragg diffraction, the radiation to be filtered is diffracted in a narrow spectral band, and the diffracted light beam is detected. The recording radiation wavelength λ_{w}, the recorded diffraction grating spacing Λ, and the wavelength λᵣ of the diffracted light beam are related by:

$$Λ = \frac{{λ}_{w}}{2 sin {θ}_{w}} , \qquad ( 6 )$$

where θ_{w} is the angle of incidence of the recording radiation on the crystal (for a symmetric recording geometry), and

λᵣ=2Λ sin θₚ, (7)

where θₚ is the angle of incidence of the incoming polychromatic radiation.

Eqs. (6) and (7) provide the expression for the wavelength of the diffracted beam:

$${λ}_{r} = {λ}_{w} \frac{sin {θ}_{p}}{sin {θ}_{w}} , \qquad ( 8 )$$

from which it follows that the wavelength λᵣ of the diffracted light is independent of the index of refraction n of the crystal. Hence, electrooptical properties of the crystal cannot be used to tune the filter in accordance with the above-described method.

The last two described methods do not involve forming a fixed holographic grating in the crystal. Incoming radiation is filtered by the grating which is continuously recorded in the crystal, without being fixed in it, resulting in a substantially higher diffraction efficiency of the grating compared to that of a fixed grating. Unfortunately, as shown above, the two methods do not utilize the possibility of tuning the filter by an electrical field.

### SUMMARY OF THE INVENTION

The present invention provides a method of spectral filtration of optical radiation by forming a holographic diffraction grating in a photorefractive medium. The photorefractive medium can be a crystal, a polymer or any other material with suitable photorefractive properties. The wavelength of the filtered radiation can be selected depending on the electrooptical properties of the photorefractive material, by applying an electric field and, in addition, by sufficiently high transfer function parameters achieved due to a high diffraction efficiency of the grating can be obtained.

According to the method of the present invention, the method for spectral filtering of optical radiation based on diffraction from a holographic diffraction grating comprises forming the grating in a photorefractive material by directing two coherent light beams onto a face of the photorefractive material at some angle, intersecting two coherent light beams inside the material and directing a radiation beam onto the photorefractive material preferably along the diffraction grating wave vector (also called a grating vector). The direction of the grating wave vector in the described system is not parallel to the directions of propagation of the two coherent light beams.

When the radiation beam propagates along the wave vector, a spectral component with a wavelength λᵣ of the light beam reflected from the grating is described by Eq. (1). For the above-described recording geometry the grating period Λ is determined from Eq. (6). Thus, Eqs. (1) and (6) yield the wavelength λᵣ for the present invention as follows:

$${λ}_{r} = {λ}_{w} \frac{n}{sin {θ}_{w}} . \qquad ( 9 )$$

It can be seen that Eq. (9) includes an average refractive index n of the material, which means that λᵣ can be changed by varying n. Therefore, if such a filter is made of a material with the appropriate electrooptical properties, it can be electrically tuned to filter out the desired λᵣ.

In other words, the method of spectral filtration of radiation comprises providing a photorefractive medium, a first and a second coherent light beams intersecting in the photorefractive medium and forming a diffraction grating inside the photorefractive medium, the diffraction grating defining a grating vector, directing a polychromatic beam into the photorefractive medium along the direction of the grating vector, and filtering a spectral component of the polychromatic beam by diffracting the polychromatic beam on the diffraction grating. It is further contemplated that the method further comprises applying a voltage to the photorefractive medium and selecting a wavelength of the spectral component by selecting the voltage applied to the photorefractive medium. The method further comprises selecting a wavelength of the spectral component by selecting wavelengths of the first and the second coherent light beams. Providing the first and the second light beams comprises causing the first and the second light beams to impinge on the photorefractive medium at an angle. In addition, the method comprises selecting a wavelength of the spectral component by selecting the angle at which the first and the second light beams impinge on the photorefractive medium. Applying a voltage to the photorefractive medium comprises providing a pair of electrodes. The photorefractive medium can be a crystal, a polymer or any other material with suitable photorefractive properties.

Since in the described method of spectral filtration high diffraction efficiency can be provided without the need to fix the grating in the material, materials with a high electroopotical coefficient can be selected as filter materials regardless of their ability to fix a grating. Therefore, a filter providing simultaneously a high diffraction efficiency and the ability to tune electrically to a broad range of wavelengths λᵣ can be fabricated.

Additionally, the tuning range of the filter can be substantially increased by varying the wavelength λ_{w} of the light beams forming the interference pattern in the material, and recording a grating with a different period Λ. In this embodiment of the present invention, the filtered wavelength λᵣ of the radiation beam is determined by presetting the wavelength λ_{w} of the recording light beams.

Additionally, the tuning range of the filter can be broadened by varying the angles of incidence of the recording light beams θ_{w}, which also leads to the recording of a grating with a different spacing Λ. In this embodiment of the present invention, the filtered out wavelength λᵣ of the radiation beam is determined by presetting the angle θ_{w}.

The present invention also provides a device, a n optical filter, comprising a photorefractive medium; means for providing a first and a second coherent beams intersecting in the photorefractive medium and forming a diffraction grating in the photorefractive medium, the diffraction grating defining a grating vector; and means for directing a polychromatic beam into the photorefractive medium along the grating vector. While several specific embodiments of the device are illustrated in FIGS. 2 and 3 and are described in more detail below, it is understood by those skilled in the art that there exist numerous embodiments accomplishing directing the polychromatic beam into the photorefractive medium along the grating vector. These embodiments fall within the scope and spirit of the means for directing the beam into the medium, as described and claimed below. Similarly, those skilled in the art can readily understand that numerous embodiments can be used to implement means for providing a first and a second coherent beams capable of intersecting in the photorefractive medium. It is understood that the scope of the present invention encompasses all embodiments of such means.

In addition, according to the present invention, the filter further comprises a pair of electrodes for applying a voltage to the photorefractive medium. The means for providing a first and a second coherent light beams comprise a source capable of generating a radiation beam and a semitransparent reflector capable of splitting the radiation beam into the first and the second coherent light beams. The device further comprises a first deflector serving to direct the first coherent beam onto the photorefractive medium and a second deflector serving to direct the second coherent beam onto the photorefractive medium. As an example, the means for directing a polychromatic beam can comprise optical fibers directing the polychromatic beam in and out of the photorefractive medium.

### BRIEF DESCRIPTION OF THE DRAWINGS

The present invention will be described with reference to the drawings of the following figures:

FIG. 1 is a schematic diagram of one of the embodiments of the present invention.

FIG. 2 is a schematic diagram of an embodiment of the present invention.

FIG. 3 is a schematic diagram of an embodiment of the present invention.

### DETAILED DESCRIPTION OF THE INVENTION

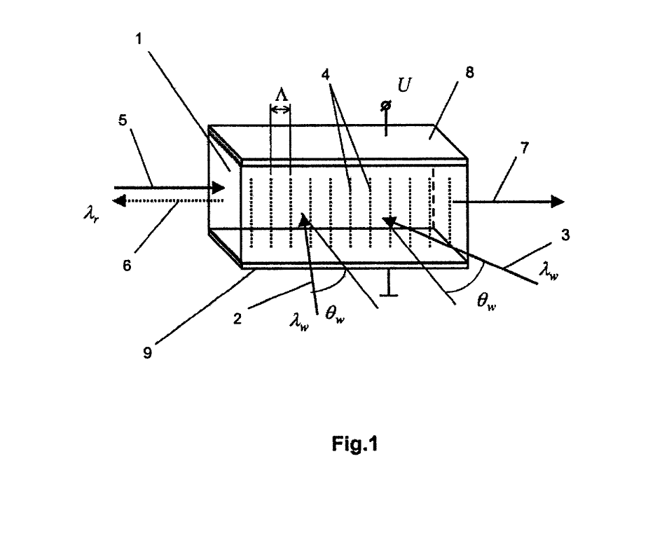

One of the embodiments of the present invention is shown in FIG. 1. In a photorefractive material, such as crystal 1, having the desired electrooptical coefficient, a holographic diffraction grating 4 of a period Λ determined by Eq. (6) is continuously recorded by intersecting two coherent light beams 2 and 3 of a wavelength λ_{w} incident on one of faces of crystal 1 at angle θ_{w}. A radiation beam 5 to be filtered is directed onto another face of crystal 1 preferably along the wave vector of grating 4. A light beam 6 of a wavelength λᵣ that satisfies the Bragg condition and described by Eq. (9) is reflected from grating 4, and a light beam 7 with the wavelengths that do not satisfy the Bragg condition passes through optically transparent crystal 1. Index of refraction n in crystal 1 can be changed by an electric field generated in the crystal by electrodes 8 and 9. In accordance with Eq. (9), changes in the refractive index n of crystal 1 result in the changes of wavelength λᵣ of reflected light beam 6.

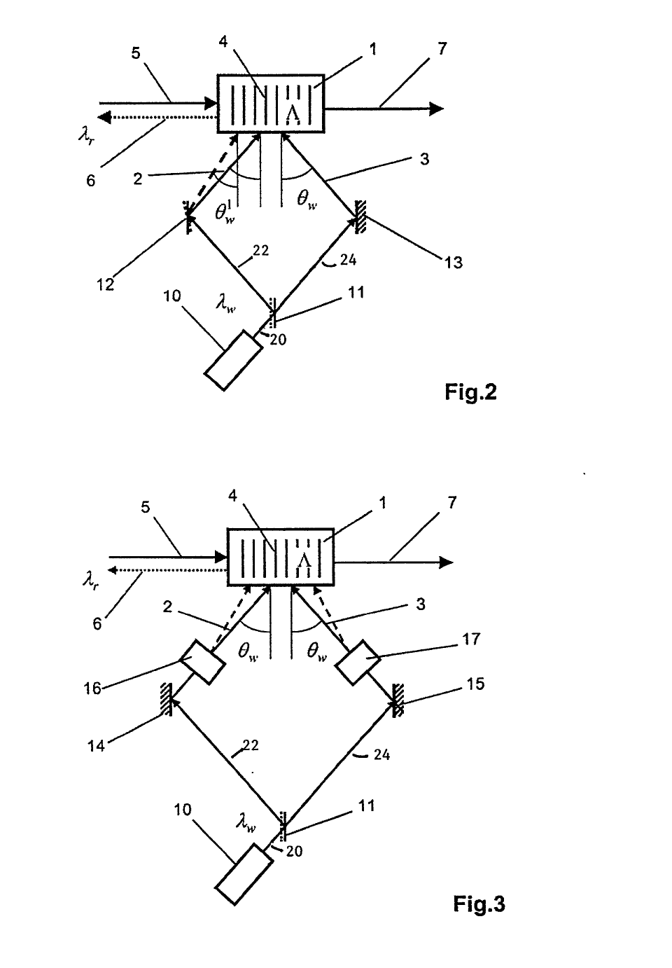

According to Eq. (9), wavelength λᵣ and spacing Λ can also be changed by varying wavelengths λ_{w}of light beams 2 and 3, which can be accomplished by using a tunable semiconductor laser, but such a change is slower compared to the changes caused by a varying electric field in crystal 1, because the earlier recorded grating must be erased before a new grating is recorded. For such crystals as BaTiO₃ and the intensities of the recording light beams 2 and 3 of the order of 1 W/cm², the duration of this process is approximately 1 s. In the scheme with an electrically controlled tuning of wavelength λᵣ, variation in wavelength λ_{w} of recording light beams 2 and 3 will lead to selection of the spectral range in which the electrically controlled filter operates. As follows from Eq. (9), the operating range of the filter can also be selected by varying the angles of incidence of recording light beams 2 and 3. Therefore, spacing Λ of recorded grating 4 and the spectral range in which the electrically controlled filter operates change. Examples of various embodiments of the present invention using the method of selection of a spectral range of a filter varying the angles of incidence of recording light beams 2 and 3 are shown in FIG. 2 and FIG. 3.

An embodiment of the present invention shown in FIG. 2 comprises a laser 10 having a wavelength λ_{w}, a semitransparent mirror 11 and two mirrors 12 and 13. One or both of the mirrors can be rotated through some angle. Light beam 20 generated by laser 10 impinges on semitransparent mirror 11 and is split into two beams 22 and 24 which are reflected from the mirrors 12 and 13 respectively and form recording beams 2 and 3 propagating into crystal 1 and forming holographic diffraction grating 4. Radiation beam 5 is filtered as described above (see FIG. 1). Spacing Λ of grating 4 recorded in crystal 1 can be changed and, hence, the filtering range can be selected by rotating mirror 12 or both mirrors 12 and 13. Accordingly, angle θ_{w} changes become angle θ_{w}¹, which leads to a change in spacing Λ of grating 4 recorded in crystal 1. Note that variation of angle θ_{w} by rotating the mirrors 12 and 13 is a rather slow process because mechanical rotating devices are used for this purpose.

FIG. 3 shows another embodiment of the present invention where instead of rotatable mirrors electrooptical or acoustooptical deflectors are used to deflect recording light beams 2 and 3. This embodiment comprises laser 10 having a wavelength λ_{w}, semitransparent mirror 11, two mirrors 14 and 15, and also electrooptical (or acoustooptical) deflectors 16 and 17. Light beam 20 generated by laser 10 impinges on semitransparent mirror 11 and is split into two beams 22 and 24 which are reflected from mirrors 14 and 15 respectively and directed into corresponding deflectors 16 and 17. After propagating through deflectors 16 and 17, beams 22 and 24 become recording light beams 2 and 3 and enter crystal 1 to form grating 4. Optical radiation beam 5 is filtered as described above (see FIG. 1). Deflectors 16 and 17 change angle θ_{w}, which, in turn, changes spacing Λ of grating 4 in crystal 1 and ultimately changes the spectral range of the filter. Note that an embodiment utilizing only one deflector (16 or 17) is also possible.

Thus the present invention provides a method and device for spectral filtering of optical radiation having a wide tunable range of wavelengths λᵣ. Tunable filtering is achieved by independently varying index of refraction n by generating a corresponding electric field in crystal 1, wavelength λ_{w} of recording light beams 2 and 3, and angles of incidence θ_{w} of recording light beams 2 and 3.

In the embodiments of the present invention described above, the processes of recording of grating 4 in crystal 1 and filtering of the optical radiation are simultaneous. These processes can be separated by a time period comparable to the relaxation time of the grating. That is, if the light beams 2 and 3 are turned off, the process of recording grating 4 is terminated. Nevertheless, filtering of the incoming optical radiation will be possible within the relaxation period of grating 4. While the relaxation time in such crystals as barium titanate and potassium niobate is relatively short (from 10⁻³ s to 10 s), this method is useful for processing short optical signals.

What is claimed is:

1. A method of spectral filtration of radiation comprising:
providing a photorefractive medium;
providing a first and a second coherent light beams intersecting in the photorefractive medium and forming a diffraction grating inside the photorefractive medium, the diffraction grating defining a grating vector;
directing a polychromatic beam into the photorefractive medium along the direction of the grating vector;
filtering a spectral component of the polychromatic beam by diffracting the polychromatic beam on the diffraction grating.

2. The method of claim 1, further comprising applying a voltage to the photorefractive medium.

3. The method of claim 2, further comprising selecting a wavelength of the spectral component by selecting the voltage applied to the photorefractive medium.

4. The method of claim 1, further comprising selecting a wavelength of the spectral component by selecting wavelengths of the first and the second coherent light beams.

5. The method of claim 1, wherein providing the first and the second light beams comprises causing the first and the second light beams to impinge on the photorefractive medium at an angle.

6. The method of claim 5, further comprising selecting a wavelength of the spectral component by selecting the angle at which the first and the second light beams impinge on the photorefractive medium.

7. The method of claim 2, wherein applying a voltage to the photorefractive medium comprises providing a pair of electrodes.

8. The method of claim 1, wherein providing a photorefractive medium comprises providing a photorefractive crystal.

9. A device comprising:
a photorefractive medium;
means for providing a first and a second coherent beams capable of intersecting in the photorefractive medium and forming a diffraction grating in the photorefractive medium, the diffraction grating defining a grating vector; and
means for directing a polychromatic beam into the photorefractive medium along the grating vector.

10. The device of claim 9, further comprising a pair of electrodes for applying a voltage to the electooptical medium.

11. The device of claim 9, wherein the means for providing a first and a second coherent light beams comprise a source capable of generating a radiation beam and a semitransparent reflector capable of splitting the radiation beam into the first and the second coherent light beams.

12. The device of claim 9, further comprising a first deflector serving to direct the first coherent beam onto the photorefractive medium and a second deflector serving to direct the second coherent beam onto the photorefractive medium.

13. The device of claim 9, wherein the means for directing a polychromatic beam comprises optical fibers directing the polychromatic beam in and out of the photorefractive medium.

14. The device of claim 9, wherein the photorefractive medium is a crystal.
